(19) United States
(12) Patent Application Publication
(10) Pub. No.: US 2013/0153058 A1
(43) Pub. Date: Jun. 20, 2013

(54) PRESSURE REDUCER

(71) Applicant: Willi Hecking, Niederkrunchten-Elmpt (DE)

(72) Inventor: Willi Hecking, Niederkrunchten-Elmpt (DE)

(73) Assignee: Hans Sasserath & Co. KG, Korschenbroich (DE)

(21) Appl. No.: 13/621,077

(22) Filed: Sep. 15, 2012

(30) Foreign Application Priority Data
Sep. 23, 2011 (DE) 20 2011 051 425.0

(51) Int. Cl. F16K 17/00

(52) U.S. Cl. CPC F16K 17/00
USPC 137/505

(57) ABSTRACT

A pressure reducer assembly having a connection fitting for connecting the pressure reducer assembly to a pipe or other water containing element, the connection fitting having a housing with an opening, an inlet exposed to an inlet pressure, an outlet exposed to an outlet pressure, and a separating wall inside the housing for separating the inlet from the outlet and having an opening in the separating wall. A pressure reducer insert extends from the housing opening. The pressure reducer insert is designed in such a way that the pressure effective cross section of the pressure reducer insert which is exposed to the inlet pressure is essentially the same as the pressure effective cross section of the pressure reducer insert in the opening in the separating wall exposed to the inlet pressure. This allows the pressure reducer insert to be made of plastic material.

### TECHNICAL FIELD

The invention relates to a pressure reducer assembly comprising
(a) a connection fitting for connecting a pressure reducer to a pipe or any other water containing element with a housing, an inlet and an outlet provided at the housing and a separating wall for separating the inlet from the outlet;
(b) a pressure reducer valve controlled by the pressure of a spring for adjusting the outlet pressure downstream of the pressure reducer valve, and
(c) a pressure reducer insert inserted into the connection fitting, the insert extending on one side to an opening in the separating wall and being sealed against the separating wall and extending through an opening in the housing and being sealed against the housing.

Such pressure reducer assemblies operate with a valve which opens if the outlet pressure drops and closes as soon as a threshold value for the outlet pressure is reached. In such a way the outlet pressure can be adjusted to a desired value. Pressure changes, such as, for example, caused by the drinking water supply, are compensated in such a way. Especially when high inlet pressures occur the pressure can be adjusted to a low value thereby achieving a saving on the water consumption. Pressure reducers are used in particular with devices requiring constant pressure conditions.

### PRIOR ART

Pressure reducers are well known in the art, for example from DE 20 2009 013 661.2 or DE 10 2007 011228 A1. Known pressure reducers comprise a housing with a housing socket. A pressure reducer insert normally having the shape of a hopper is inserted into the socket in the housing. A screw cap housing with a spring is screwed onto the housing socket. A control chamber with outlet pressure is limited by a control diaphragm, which is clamped in known assemblies between the housing side end of the screw cap housing and a shoulder of the housing socket. A separating wall is provided inside the housing separating the inlet chamber from the outlet chamber. There is inlet pressure in the inlet chamber. There is outlet pressure in the outlet chamber. The hopper-shaped pressure reducer insert forms a valve seat. A valve closing body is connected to a valve spindle which is shiftably guided in the pressure reducer insert. The inside of the pressure reducer insert is connected to the inlet chamber. Thereby it is achieved that there is inlet pressure upstream of the valve inside the pressure reducer insert as well as in the inlet side range outside the pressure reducer insert.

The hopper-shaped form of the pressure reducer insert causes the surface of the pressure reducer insert which is exposed to the inlet pressure to be larger at its wide end than at its small end. Accordingly, forces will occur caused by the inlet pressure on the pressure reducer insert which are compensated by the housing.

Upon use of the pressure reducer for controlling of for example, drinking water, the inlet pressure and the outlet pressure are relatively small. Typical values are in the range of a few bar. The occurring forces are relatively small with such pressure values and enable the use of inexpensive plastic material for the screw cap housing.

There are, however, applications, especially industrial applications, where a much higher inlet pressure is used, such as, for example, above 25 bar. The occurring forces with such applications are large and must be taken into account. In this case the screw cap housing and the housing with the housing socket are made entirely of high-pressure resistant brass. Brass is much more expensive than plastic.

### DISCLOSURE OF THE INVENTION

It is an object of the invention to provide a device of the above mentioned kind, which is simple and suitable for high pressure applications and which enables the use of inexpensive plastic material.

According to an aspect of the invention, this object can be achieved in that
(d) the pressure reducer insert is designed in such a way that the pressure effective cross section of the pressure reducer insert in the opening of the housing which is exposed to the inlet pressure is essentially the same as the pressure effective cross section of the pressure reducer insert in the opening in the separating wall exposed to the inlet pressure, and
(e) the pressure reducer insert is made of plastic material.

This means that the pressure reducer insert is not hopper-shaped anymore, but has the same pressure effective cross section at the important positions at the housing opening and at the opening in the separating wall. Thereby the forces caused by the inlet pressure in the direction of the housing opening are compensated by forces exactly opposite thereto in the direction of the separating wall. The resulting force is zero and entirely independent from the inlet pressure.

The assembly according to the invention avoids that forces are transferred to the housing or to the screw cap housing. Thereby, it is possible to produce individual components, such as the screw cap housing and the pressure reducer insert, from inexpensive plastic material even for high pressure applications.

A preferred embodiment of the invention provides that the pressure reducer insert is essentially cylindrical. The opening of the housing can be a socket and the pressure reducer insert can extend through the socket. The socket is then integrated in the housing of the connection fitting and only serves to receive the pressure reducer insert. Accordingly, it may be relatively short.

Preferably, the spring is arranged inside a screw cap housing screwed into an adapter which is screwed onto the socket. The adapter may also consist of inexpensive plastic material. The adapter substitutes a large portion of the housing socket made of brass according to the prior art. This causes a considerable material saving of brass material.

When an adapter is used, a control diaphragm may be provided, the control diaphragm having a rim which is clamped between the fitting side end of the screw cap housing and an annular shoulder on the inside of the adapter. The control diaphragm limits a control chamber connected to the outlet in such a way that the control chamber is exposed to outlet pressure, wherein the connection between the control chamber and the outlet is established by control bore holes in the housing of the connection fitting. Alternatively, it is possible to establish the connection between the control chamber and the outlet through control bore holes in webs in the pressure reducer insert or through a central control bore hole in the valve spindle.

The pressure reducer valve may be provided with a valve seat which is integrated into the pressure reducer insert which is immobile with respect to the housing. Furthermore, the pressure reducer valve may be provided with a valve closing body connected to a valve spindle which is shiftably guided in the pressure reducer insert.

A particularly compact assembly is achieved if the moving direction of a valve spindle, the longitudinal axis of the pressure reducer insert, the opening direction of the pressure reducer valve, the opening in the housing and the opening in the separating wall are coaxially arranged and perpendicular to the longitudinal axis of the connection fitting.

Further modifications of the invention are subject matter of the subclaims. An embodiment is described below in greater detail with reference to the accompanying drawings.

### BRIEF DESCRIPTION OF THE DRAWINGS

FIG. 1 is a cross section through a pressure reducer assembly for high pressure applications.

FIG. 2 is an exploded view of the pressure reducer assembly of FIG. 1.

FIG. 3 is a perspective side view of a pressure reducer insert for a pressure reducer assembly of FIG. 1.

FIG. 4 is a perspective view of the pressure reducer insert of FIG. 3.

FIG. 5 is a perspective view of an adapter for a pressure reducer assembly of FIG. 2.

### DESCRIPTION OF THE PREFERRED EMBODIMENT

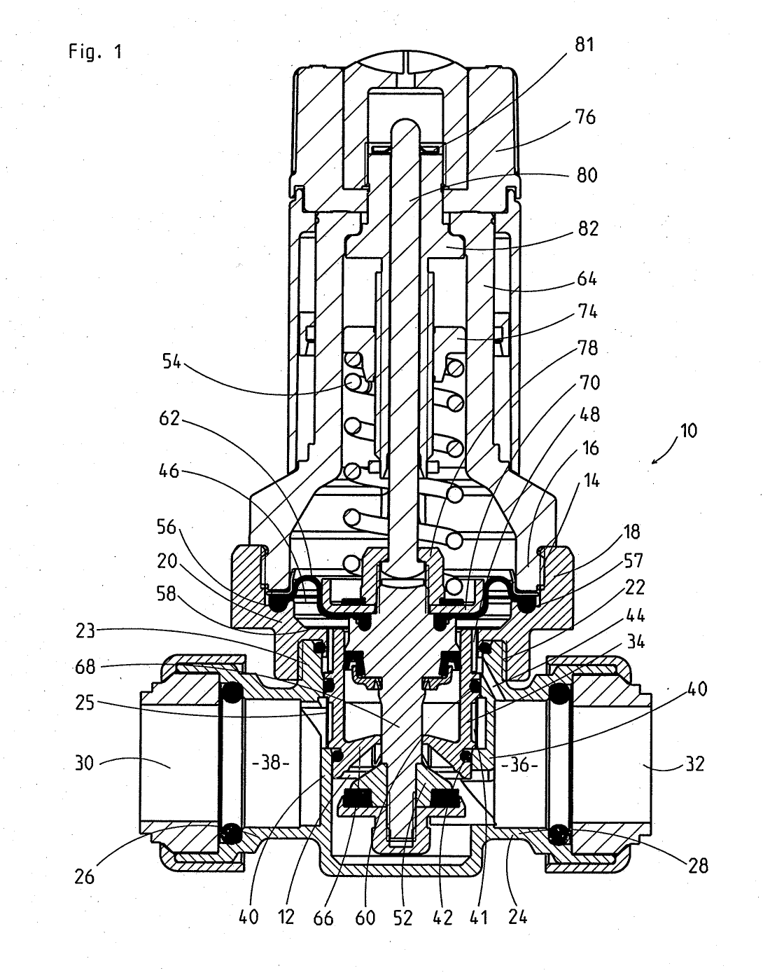

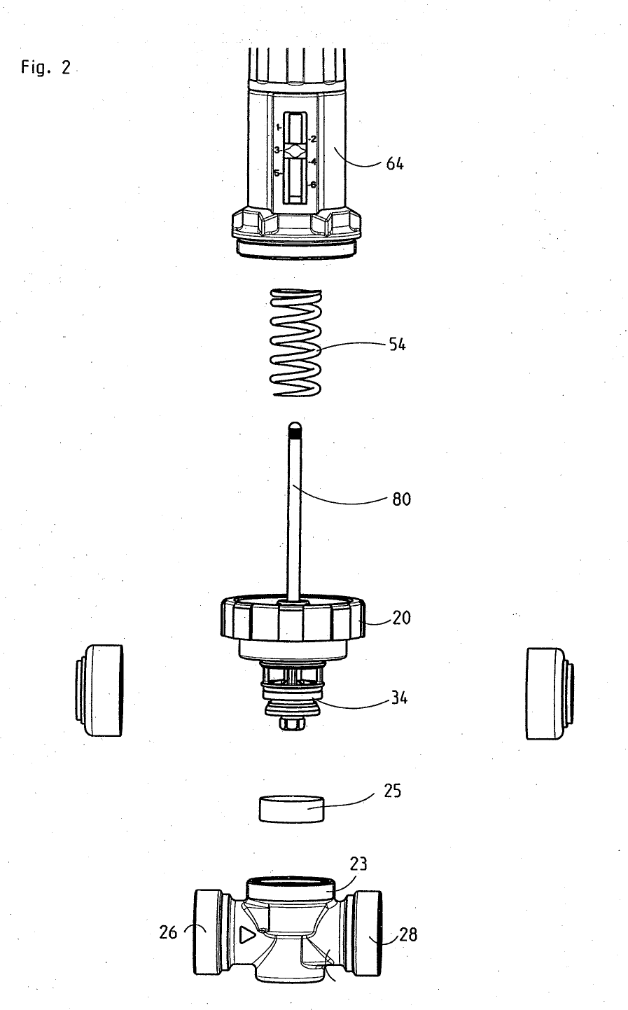

FIGS. 1 and 2 show a pressure reducer assembly generally denoted with numeral 10 with a pressure reducer valve 12. A pressure reducer is generally known. A screw cap housing 64 of the pressure reducer assembly 10 with an outer thread 14 at its lower end 16 is screwed into the inner thread of an adapter socket 18. The adapter socket 18 is a portion of an adapter 20 made of inexpensive plastic material, which is screwed with a thread 22 on the housing socket 23 of a connection fitting 24 having a brass housing.

The connection fitting 24 is provided with an inlet connection 26 with an inlet 30 and an outlet connection 28 with an outlet 32. The inlet 30 forms an inlet chamber 38 with inlet pressure. The outlet 32 forms an outlet chamber 36 with outlet pressure. This can be seen in FIG. 1. The connection fitting 24 is installed in a pipe (not shown) with the inlet connection 26 and the outlet connection 28. Drinking water from a drinking water supply is fed from the inlet 30 through the pressure reducer assembly described below to the outlet 32. The outlet pressure at the outlet 32 is adjusted with the pressure reducer assembly 10 as described below:

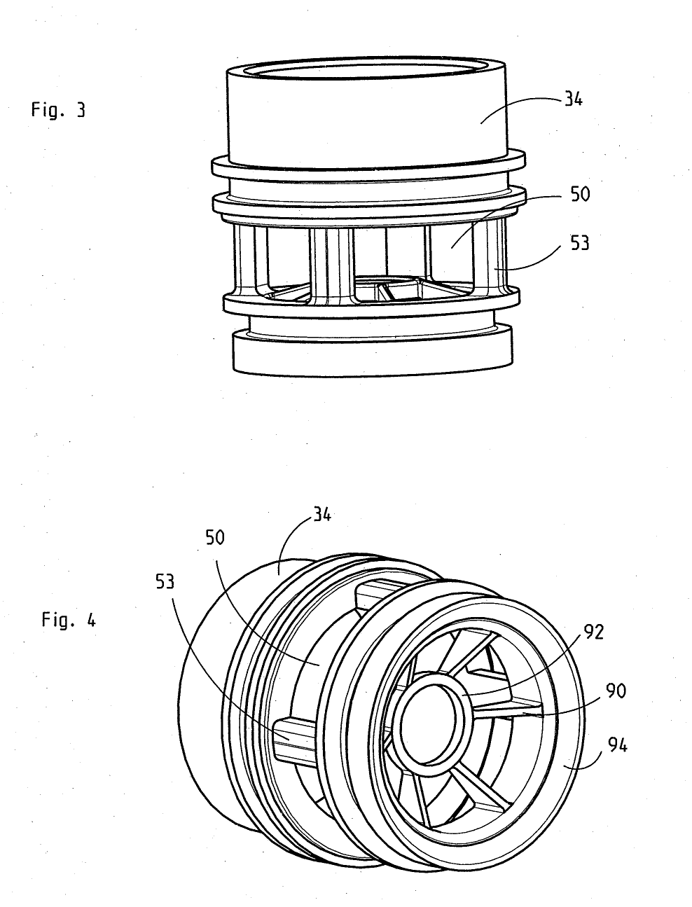

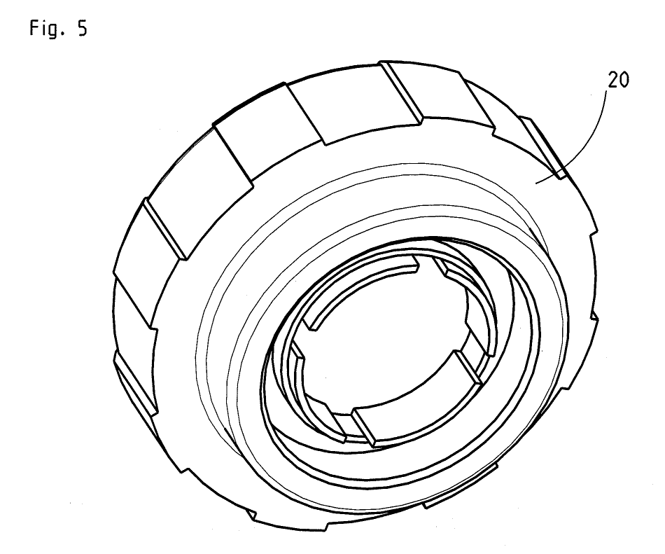

The adapter 20 forms a first, upper annular shoulder 56 on its inside and a second, lower annular shoulder 58 there below. A pressure reducer insert 34 coaxially extends through the adapter and the socket 23 into the housing of the connection fitting 24. The adapter 20 is separately shown again and in greater detail in FIG. 5. The pressure reducer insert 34 is shown again and in greater detail in FIGS. 3 and 4.

The pressure reducer insert 34 has an essentially cylindrical basic shape. The upper range of the pressure reducer insert 34 ends at the height of the lower annular shoulder 58. A sealing ring 60 between two projections along the circumference seals the outside of the pressure reducer insert 34 against the inside of the housing socket 23.

The separation of the inlet chamber 38 and the outlet chamber 36 is effected essentially with a separating wall 40 integrated in inside wall of the connection fitting 24 in the inlet range. This can be seen in the cross sectional view of FIG. 1. The separating wall 40 has a wall portion extending essentially parallel to the pipe axis of the connection fitting 40. An opening is provided in such wall portion and the pressure reducer insert 34 extends through this opening. A sealing 42 on the outside of the pressure reducer insert 34 seals the pressure reducer insert 34 against the separating wall and thereby against the inlet chamber 38 and the outlet chamber 36. An annular channel 41 runs between the sealings 60 and 42 extending from the inlet chamber 38 around the pressure reducer insert 34 to the separating wall 40. Both sealings are, therefore, exposed to inlet pressure. As the sealings 42 and 60 have exactly the same diameter and thereby the assembly is pressure compensated the resulting forces on the pressure reducer insert are compensated.

A sealing ring 57 is positioned on the upper shoulder 56 of the adapter 20. The rim of a control diaphragm 62 lays on the sealing ring 57. The control diaphragm 62 is clamped between the screw cap housing 64 and the adapter 20. The outer thread 14 on the lower range of the screw cap housing 64 is screwed into the inner thread of the adapter 20.

The adapter 20 and the control diaphragm 62 form a control pressure chamber 46. The outlet chamber 36 is connected to the outlet 32. The pressure reducer valve 12 of the pressure reducer assembly 10 is arranged between the inlet chamber 38 and the outlet chamber 36, the pressure reducer valve 12 controlling the outlet pressure of the assembly. A channel 44 in the housing of the connection fitting 24 with vertical connections 48 between the range outside the pressure reducer insert 34 and the inner wall of the housing socket 23 connects the outlet 32 to the control pressure chamber 46 through the outlet chamber 36. Therefore, there is outlet pressure in the control pressure chamber 46.

In its lower range the pressure reducer insert 34 is provided with inwardly extending webs 90 ending in a ring 92. The webs 90 are connected to an annular wall portion 94 at the other end, forming a valve seat 66. This can be well seen in FIG. 4. The valve seat 66 forms the pressure reducer valve 12 together with a valve plate 52. The valve plate 52 and the control diaphragm 62 are tightly connected to a valve spindle 68. The control diaphragm 62 and a diaphragm plate 70 on the control diaphragm 62 are clamped with a nut 78. The nut 78 is screwed onto the upper end of the valve spindle 68. The valve spindle 68 is sealingly and moveably guided in the pressure reducer insert 34. The valve spindle 68 extends beyond the insert 34 to the valve plate 52. In a further embodiment of the invention which is not shown, the connection between the outlet chamber 36 and the control pressure chamber 46 is established through channels in separate webs. In a still further embodiment of the invention which is not shown, the connection between the outlet chamber 36 and the control pressure chamber 46 is established through a central channel in the valve spindle. In the range of the annular channel 41 the pressure reducer insert 34 is provided with vertical webs 53 forming passages 50 into the inside of the pressure reducer insert 34. They can be well recognized in FIGS. 3 and 4. Water flowing from the inlet 30 into the inlet chamber 38 reaches the range behind the pressure reducer valve 12 through the annular channel 41 and the passages of the pressure reducer insert 34.

The upper end of the helical spring 54 is supported at a spring abutment 74. The spring abutment 74 can be axially adjusted. Thereby, the bias of the helical spring 54 can be set. This bias of the helical spring 54 is effective at the control diaphragm 62 against the pressure of the control pressure chamber 46, i.e. against the outlet pressure. The valve plate 52 is fixed to the valve spindle 68 with a sealing. The valve plate 52 cooperates with the valve seat 66. The valve spindle 68 and the valve plate 52 fixed thereto are moved in such a way by the control diaphragm 62, that an equilibrium state is achieved. Therefore, the adjustment of the bias of the helical spring 54 determines the outlet pressure.

The valve plate 52 is moved downwards in the representation upon small outlet pressure and the valve 12 is opened. The valve plate 52 is moved upwards into the valve seat 66 upon high outlet pressure and the valve closes. Then, no more water can flow from the inlet to the outlet. If the outlet pressure in the outlet 32 and thereby in the outlet chamber 36 decreases, such as upon tapping water, the valve plate 52 of the valve 12 is moved downwards due to the spring pressure of the spring 54 and the valve 12 opens until the adjusted outlet pressure is established again.

The enlarged end of a spindle 80 is connected to the valve spindle 68 by means of the nut 78. The spindle 80 is freely moveable in an axial direction in the bore of a coaxial threaded spindle 82. A securing disc is connected to the spindle 80. The screw cap housing 64 can be released from the assembly together with the adapter 20. The pressure settings will then remain set due to the securing disc. In such a way a sieve 25 in the annular chamber 41 can be easily cleaned. The threaded spindle 82 is provided with an outer thread. The spring abutment 74 is screwed onto this thread. The threaded spindle 82 is provided with a multiedge profile at its upper end which is remote from the valve. An adjusting handle 76 can be used to turn the threaded spindle 82 until the spring abutment 74 has a desired position and thereby the spring has the desired biasing force.

The upper portion of the threaded spindle 82 is enlarged and forms a stop for the spring abutment 74. The spindle 80 extends through a center bore in the handle. The spindle 80 is freely moveable in the bore of the threaded spindle 82 and the handle 76. The handle 76 is screwed on the upper portion of the screw cap housing. The handle 76 moves in an axial direction upwards or downwards in the drawing upon rotation.

FIG. 1 shows the case of the normal, open operating position with open pressure reducer valve 12. The valve is in this position, for example, if water is tapped and the outlet pressure drops.

It can be well seen in FIG. 1, that the housing socket 23 is relatively short thereby requiring only small amounts of brass material. The adapter 20 and the pressure reducer insert 34 are manufactured of inexpensive plastic material. The adapter 20 is exposed only to outlet pressure present in the control pressure chamber 46 which is much lower with high pressure applications than the inlet pressure. The high inlet pressure is only effective on the housing of the connection fitting 24 which consists of brass and on the pressure compensated pressure reducer insert 34.

The invention was described above with a particularly simple assembly with a control diaphragm. It is understood, however, that the invention may also be used with more complex assemblies. In particular it is possible to combine the pressure reducer with filters or leak protection devices.

1. A pressure reducer assembly comprising
a connection fitting for connecting said pressure reducer assembly to a pipe or any other water containing element, said connection fitting having a housing with an opening, an inlet exposed to an inlet pressure and an outlet exposed to an outlet pressure provided at said housing and a separating wall inside said housing for separating said inlet from said outlet, said separating wall having an opening;
a pressure reducer valve and a spring exerting a pressure on said pressure reducer valve in such a way that the pressure reducer valve is controlled by said pressure of said spring for adjusting said outlet pressure downstream of said pressure reducer valve, and
a pressure reducer insert with an pressure effective cross section inserted into said connection fitting, said insert extending on one side to said opening in said separating wall and being sealed against said separating wall and extending through said opening in said housing and being sealed against said housing,
and wherein
said pressure reducer insert is designed in such a way that said pressure effective cross section of said pressure reducer insert in said opening of said housing which is exposed to said inlet pressure is essentially the same as said pressure effective cross section of said pressure reducer insert in said opening in said separating wall exposed to said inlet pressure, and
said pressure reducer insert is made of plastic material.

2. The pressure reducer assembly according to claim 1, and wherein said pressure reducer insert is essentially cylindrical.

3. The pressure reducer assembly according to claim 1, and wherein said opening of said housing is a socket and said pressure reducer insert extends through said socket.

4. The pressure reducer assembly according to claim 2, and wherein an adapter is provided which is screwed onto said socket, a screw cap housing is provided which is screwed into said adapter and wherein said spring is arranged inside said screw cap housing.

5. The pressure reducer assembly according to claim 4, and wherein a control diaphragm is provided, said control diaphragm having a rim which is clamped between a fitting side end of said screw cap housing and an annular shoulder on an inside of said adapter.

6. The pressure reducer assembly according to claim 5, and wherein said control diaphragm limits a control chamber connected to said outlet in such a way that said control chamber is exposed to said outlet pressure, wherein said connection between said control chamber and said outlet is established by a control bore hole in said housing of said connection fitting.

7. The pressure reducer assembly according to claim 4, and wherein said adapter is made of plastic material.

8. The pressure reducer assembly according to claim 1, and wherein said pressure reducer valve is provided with a valve seat which is integrated into said pressure reducer insert which is immobile with respect to said housing.

9. The pressure reducer assembly according to claim 1, and wherein said pressure reducer valve is provided with a valve closing body connected to a valve spindle which is shiftably guided in said pressure reducer insert.

10. The pressure reducer assembly according to claim 1, and wherein said moving direction of a valve spindle, said longitudinal axis of said pressure reducer insert, said opening direction of said pressure reducer valve, said opening in said housing and said opening in said separating wall are coaxially arranged and perpendicular to said longitudinal axis of said connection fitting.
